(19) United States
(12) Patent Application Publication
(10) Pub. No.: US 2025/0207672 A1
(43) Pub. Date: Jun. 26, 2025

(54) Valve Assembly for Cooling Fluid

(71) Applicant: ECO Holding 1 GmbH, Marktheidenfeld (DE)

(72) Inventors: Toni Schneider, Esslingen (DE); Dieter Maisch, Kohlberg (DE)

(73) Assignee: ECO Holding 1 GmbH, Marktheidenfeld (DE)

(21) Appl. No.: 18/984,085

(22) Filed: Dec. 17, 2024

(30) Foreign Application Priority Data
Dec. 22, 2023 (DE) 10 2023 136 542.8

(51) Int. Cl. F16K 11/07; F16K 39/04

(52) U.S. Cl. CPC F16K 11/0712; F16K 39/04

(57) ABSTRACT

A valve assembly for cooling fluid includes: a valve housing including a valve chamber, an inflow port, a first outflow port, and a second outflow port, wherein a first flow path is formed between the inflow port and the first outflow port and a second flow path is formed between the inflow port and the second outflow port; a valve body which is arranged within the valve chamber and is configured to be movable between a first end position for enabling the first flow path, a second end position for enabling the second flow path and a central position for blocking the first and the second flow path, in particular the inflow port.

### FIELD OF THE INVENTION

The invention relates to a valve assembly for cooling fluid, comprising a valve housing comprising a valve chamber, the valve housing further comprising an inflow port, a first outflow port and a second outflow port, wherein a first flow path is formed between the inflow port and the first outflow port and a second flow path is formed between the inflow port and the second outflow port.

### BACKGROUND OF THE INVENTION

A disadvantage of the state of the art is that valves for cooling fluid are complex to manufacture, especially when the valve functions are diverse. For example, valves of this kind consist of multi-part valve sleeves with diameter variations on the inside. Consequently, valves of this kind have a complex structure and are difficult to assemble, and they have increased geometric and dimensional tolerances.

### BRIEF SUMMARY OF THE INVENTION

An aspect of the invention may provide a valve assembly for cooling fluids, which is easy to manufacture and assemble, and which has particularly versatile functions, while at the same time minimizing geometric and dimensional tolerances.

An embodiment of the invention comprises a valve assembly for cooling fluid, comprising a valve housing comprising a valve chamber, the valve housing further comprising an inflow port, a first outflow port and a second outflow port, wherein a first flow path is formed between the inflow port and the first outflow port and a second flow path is formed between the inflow port and the second outflow port. Furthermore, the valve assembly comprises a valve body which is arranged within the valve chamber and is configured to be movable between a first end position for enabling the first flow path, a second end position for enabling the second flow path and a central position for blocking the first and the second flow path, in particular the inflow port.

This has the technical advantage, for example, that no diameter steps are required inside the valve housing and on the guiding surfaces of the valve piston. Both the valve housing and the valve body are simple to manufacture while at the same time being highly precise. In addition, a large number of valve functions can be realized based on this concept, thus achieving a high degree of flexibility. In the central position, the valve body covers the entire inlet opening, blocking the flow of fluid in both the first and second discharge directions. When the valve body is moved to the first end position, the first flow path opens. When the valve body is moved to the second end position, the second flow path opens.

Thus, the valve assembly is designed to be continuously adjustable between the first end position, in which the first flow path is open and the second flow path is blocked, via the central position, in which the fluid flow is blocked in both directions, and the second end position, in which the first flow path is blocked and the second flow path is open.

According to a preferred embodiment, the valve body is formed by a valve piston that is linearly displaceable between the first end position and the second end position.

According to a particular embodiment, the valve piston comprises a first sealing portion that seals against the valve housing. This has the technical advantage, for example, that the sealing function can be realized steplessly, independent of the position of the valve piston. In other words, sealing is basically ensured by the first sealing portion when the sealing portion is in radial contact with the valve chamber wall of the valve housing. In addition, the valve piston comprises a second sealing portion 221 that supports the stepless sealing function independently of the position of the valve piston. The second sealing portion is also in radial contact with the valve chamber wall of the valve housing.

According to a further advantageous embodiment, the first sealing portion extends annularly around the valve piston. Along a valve piston longitudinal axis of the valve piston, the first sealing portion comprises a length which is greater than a length of the inflow geometry of the inflow port. This has the technical advantage, for example, that the fluid flow is closed in both directions in the central position of the valve piston.

According to an additional embodiment, the first sealing portion comprises a sealing element for engagement with a valve chamber wall and a biasing means for radially positioning the sealing element against the valve chamber wall. This has the technical advantage, for example, that the leakage of the operating fluid can be largely reduced. The biasing means is arranged radially within the sealing element and thus causes the sealing element to be in contact with the valve chamber wall as completely as possible. For example, the biasing means and the sealing element are formed in one piece. The second sealing portion functions in a corresponding manner.

According to a further particular embodiment, the biasing means comprises a first biasing element and a second biasing element, the first biasing element and the second biasing element being arranged at a distance from one another in the direction of the valve piston longitudinal axis L. This has the technical advantage, for example, that the contact of the sealing element is ensured as completely as possible over the entire length and that the highest contact pressure is applied at the two sealing ends in the closed central position. This additionally reduces the leakage of the operating medium.

According to a particularly preferred embodiment, the inflow port comprises a first opening contour that is configured to open the second flow path with a first slope S1 of a flow cross-section expansion when the valve piston is moved to the second end position. In addition, the inflow port comprises a second opening contour that is configured to open the first flow path with a second slope S2 of a flow cross-section expansion when the valve piston is moved to the first end position, wherein the first slope S1 may differ from the second slope S2.

When the valve piston is moved to the first end position, the sealing element moves out of the central position and opens the first flow path at the moment when the sealing element loses its radial contact with a valve chamber wall. The gap that opens up as a result is initially very small in the axial direction, which means that a small flow cross-section is released and correspondingly little operating medium can flow through the flow cross-section. The further the sealing element is moved in the direction of the first end position, the larger the first flow cross-section becomes and the more operating medium can flow through the first flow path. In other words, the larger the first flow cross-section, the more operating medium can flow through the first flow path. Because the first flow cross-section is larger the further the sealing element is moved towards the first end position, there is an almost proportional relationship between the position of the sealing element and the volume of the operating medium flowing through the first flow cross-section.

This has the technical advantage, for example, that the second opening contour is configured differently than the first opening contour. This can be used, for example, to ensure that the flow behavior in the direction of the first flow path differs from the flow behavior in the direction of the second flow path, at least when the first flow path is opened. It is particularly advantageous, for example, that more operating medium can flow through the first flow path per distance travelled by the sealing element in the direction of the first end position because the flow cross-section increases faster than the operating medium can flow through the second flow path for the same distance travelled by the sealing element in the direction of the second end position. It can also be achieved by means of a corresponding pilot control geometry that not the entire radial circumference is opened at the beginning, but only individual segments, so that a soft and easily controllable opening takes place here.

Preferably, it can also be designed in the opposite direction, in that less operating medium can flow through the second flow path per distance travelled by the sealing element in the direction of the second end position, because the flow cross-section increases more slowly than operating medium can flow through the first flow path in the direction of the first end position for the same distance travelled by the sealing element.

According to a further preferred embodiment, an annular groove in the valve chamber wall is assigned to the first opening contour and/or the second opening contour, the annular groove being connected to the inflow port.

The characteristic according to which the annular groove is connected to the inflow port means that the annular groove and the inflow port at least partially intersect. Thus, the slope of the ratio of the position of the sealing element and the volume of the operating medium flowing through the first flow cross-section can be influenced by means of the annular groove. For example, an annular groove is assigned to the second opening contour, whereby the flow behavior when opening the first flow path differs from the flow behavior when opening the second flow path.

According to a particularly advantageous embodiment, a cross-section geometry of the inflow port is designed to be non-uniform in the direction of the valve piston longitudinal axis. For example, the cross-section geometry can comprise a plurality of teeth, which are formed in the circumferential direction along the inflow port. Alternatively, radial openings can be formed in the valve housing at the level of the inflow port. For example, the radial openings can be formed as holes in any number.

According to a further advantageous embodiment, the valve piston comprises a third opening contour. With the help of the third opening contour, advantages comparable to those in the preceding embodiments can be achieved. In contrast to the preceding embodiments, the advantages are achieved by adapting the geometry at the valve piston.

Also in this embodiment, when the valve piston is moved to the second end position, the sealing element moves out of the central position and thus opens the second flow path at the moment when the sealing element loses its radial contact with a valve chamber wall. The gap that opens up as a result is also very small at the beginning, which means that a very small flow cross-section is released and correspondingly little operating medium can flow through the flow cross-section. The further the sealing element is moved towards the second end position, the larger the second flow cross-section becomes and the more operating medium can flow through the second flow path. Under normal circumstances, the ratio between the position of the sealing element and the size of the flow cross-section in a limited path section of the valve body is also proportional here. Thus, the larger the second flow cross-section, the more operating medium can flow through the second flow path. Because the second flow cross-section is larger the further the sealing element is moved towards the second end position, there is also an almost proportional relationship between the position of the sealing element and the volume of the operating medium flowing through the second flow cross-section.

Due to the geometry of the third opening contour, it is possible to influence the slope of the proportional relationship between the position of the sealing element and the volume of the operating medium flowing through the second flow cross-section. At least at the beginning of the opening, a very small flow change takes place over the stroke, in order to ensure good controllability at low flow rates.

This has the technical advantage, for example, that the flow behavior in the direction of the second flow path differs from the flow behavior in the direction of the first flow path.

Preferably, it can also be configured in the opposite way, in that less operating medium can flow through the first flow path per path covered by the sealing element in the direction of the first end position, because the flow cross-section increases more slowly than operating medium can flow through the second flow path for the same path covered by the sealing element in the direction of the second end position.

According to a further particular embodiment, the valve piston comprises a piston tip, the third opening contour being formed by a conical or frusto-conical tapering of the piston tip or by at least one radial recess in the piston tip which extends as far as an axial end face of the piston tip. For example, the valve piston can comprise a fourth opening contour, which is located at the opposite end of the third opening contour on the valve piston. For example, the third opening contour and the fourth opening contour are arranged on the sealing element. For example, the third opening contour and the fourth opening contour are arranged at opposite ends of the sealing element and are thus assigned to the first flow path and the second flow path. This has the technical advantage, for example, that a very low flow rate is achieved at the start of opening, thus achieving a high resolution and control quality.

Preferably, the valve assembly according to the invention comprises a purpose-specific combination of a first opening contour, a second opening contour, a third opening contour and a fourth opening contour.

According to an additional embodiment, the inflow port is formed by a round or polygonal, in particular triangular or trapezoidal, opening of the valve housing. The resulting technical advantages correspond to the advantages mentioned above. Any geometric shape is conceivable here in order to adapt the characteristic curve specifically for the purpose. These geometric shapes can be provided on each of the opening contours.

According to a particularly advantageous embodiment, the valve assembly is of a pressure-balanced design. This achieves, for example, the technical advantage that the effectively pressurized surfaces on the valve body are designed such that the surfaces that move the valve body to the right are equal in size to the surfaces that pressurize it to the left. This results in the same pressure on the left and right (pressure equalized) on the surfaces and thus an equilibrium of forces on the valve body itself. This design results in a completely force-balanced system.

According to an additional advantageous embodiment, the valve piston comprises a through-opening for pressure equalization. This achieves, for example, the technical advantage that the operating medium can flow directly through the valve body. This results in a simple and symmetrical pressure equalization of the operating medium, which overall enables the force-balanced design of the valve piston. Alternatively, the through-opening can also be realized by a bypass, which runs through the valve housing or at least not through the valve body. In either case, a connection for pressure equalization must be established between the two sides of the piston.

Preferably, the valve assembly comprises an electrically actuable drive for proportionally actuating the valve body. This has the technical advantage, for example, that the valve body can be adjusted directly and precisely. For example, the electric drive comprises a stepper motor. The combination of an electrically actuable drive and a pressure-equalized design of the valve assembly is particularly advantageous. In this case, the force required for the drive is significantly lower because no resulting force due to the operating medium has to be overcome. Consequently, the electric drive can be selected to be compact and therefore inexpensive. An additional advantage is that if the power supply is disconnected or a defect occurs in the drive, the valve body remains in the last position.

Preferably, the valve assembly is designed as a proportional valve assembly.

The following detailed description and the entirety of the patent claims provide further advantageous embodiments and feature combinations of the invention.

### BRIEF DESCRIPTION OF THE DRAWINGS

The various features described above by way of examples may be combined with each other in accordance with the invention, insofar as this is technically expedient and suitable. Further features, advantages and embodiments of the invention will become apparent from the following description of examples of embodiments and with the aid of the figures.

The drawings used to explain the examples of embodiments show:

FIG. 1A a valve assembly in a perspective sectional view according to a first embodiment;

FIG. 1B a sectional view of the lateral surface of the valve housing;

FIG. 2A a valve assembly in a schematic sectional view according to the first embodiment, wherein the valve body is in the first end position;

FIG. 2B a detailed sectional view of the valve assembly in the first end position;

FIG. 3A a valve assembly in a schematic sectional view according to the first embodiment, wherein the valve body is in the central position;

FIG. 3B a detailed sectional view of the valve assembly in the central position;

FIG. 3C a detailed sectional view of the valve assembly, wherein the valve piston is moved from the central position towards the second end position;

FIG. 3D a detailed sectional view of the valve assembly, wherein the valve piston is moved from the central position towards the first end position;

FIG. 4A a valve assembly in a schematic sectional view according to the first embodiment, wherein the valve body is in the second end position;

FIG. 4B a detailed sectional view of the valve assembly, wherein the valve piston is in the second end position;

FIG. 5A a valve assembly in a schematic sectional view according to a further embodiment, wherein the valve body is moved in the direction of the first end position;

FIG. 5B the valve assembly according to FIG. 5A, wherein the valve body is in the central position;

FIG. 5C the valve assembly according to FIG. 5A, wherein the valve body is moved in the direction of the second end position;

FIG. 6 an exemplary illustration of the development of a flow cross-section expansion of the first flow path and the second flow path when the valve body is moved between the first end position and the second end position;

FIG. 7A a valve assembly in a sectional view according to an additional embodiment;

FIG. 7B a valve assembly in a plan view according to the embodiment of FIG. 7A;

FIG. 7C a valve body in a schematic side view according to a further embodiment; and

FIG. 8 a further exemplary representation of the development of a flow cross-section expansion of the first flow path and the second flow path when the valve body is moved from the first end position to the second end position.

In the figures, the same parts are generally provided with the same reference signs.

### DETAILED DESCRIPTION

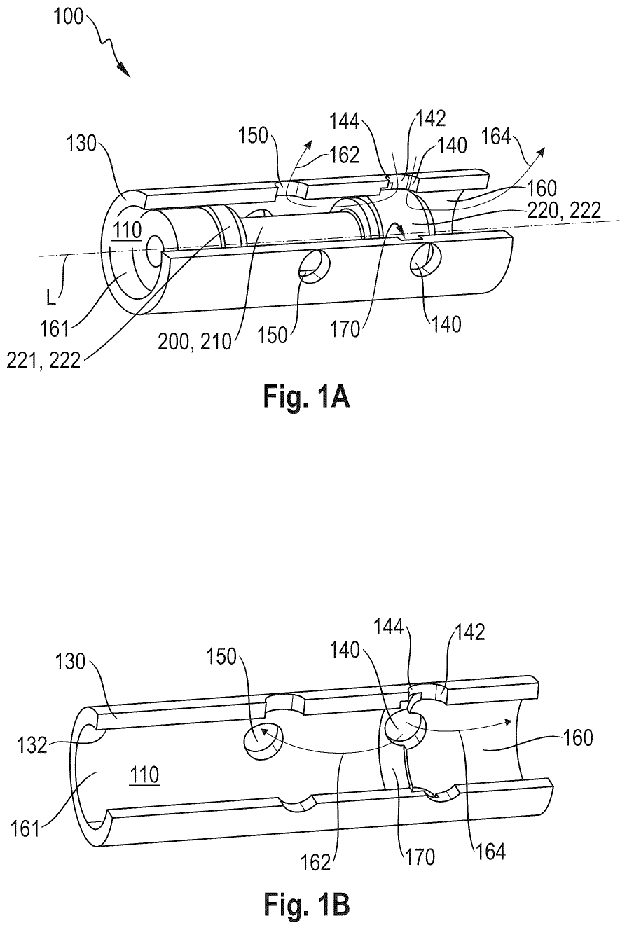

FIG. 1A shows a valve assembly 100 in a perspective sectional view according to a first embodiment. The valve assembly 100 comprises a valve chamber 110, which is arranged in a valve housing 130. The valve housing 130 comprises an inflow port 140, a first outflow port 150 and a second outflow port 160. A first flow path 162 may be formed between the inflow port 140 and the first outflow port 150, and a second flow path 164 may be formed between the inflow port 140 and the second outflow port 160. The opening or closing of the first and second flow paths 162, 164 depends in each case on the position of a valve body 200. The valve body 200 is arranged within the valve chamber 110 and is designed to move between a first end position P1 for releasing the first flow path 162, a second end position P2 for releasing the second flow path 164 and a central position M for blocking the first and second flow paths 162, 164. In the central position M, the inflow port 140 is closed. The valve body 200 comprises a valve piston 210 that is linearly displaceable between the first end position P1 and the second end position P2, the valve piston 210 comprising a first sealing portion 220. The first sealing portion 220 is arranged around the valve piston 210 in an annular fashion and seals with respect to the valve housing 130. In addition, the valve piston 210 comprises a second sealing portion 221. The second sealing portion 221 also comprises a sealing element 222 for bearing against the valve chamber wall 132 and a biasing means (not shown) for radial positioning of the sealing element 222 on the valve chamber wall 132. The second sealing portion 221 seals the first flow path 162 with respect to a free outflow port 161.

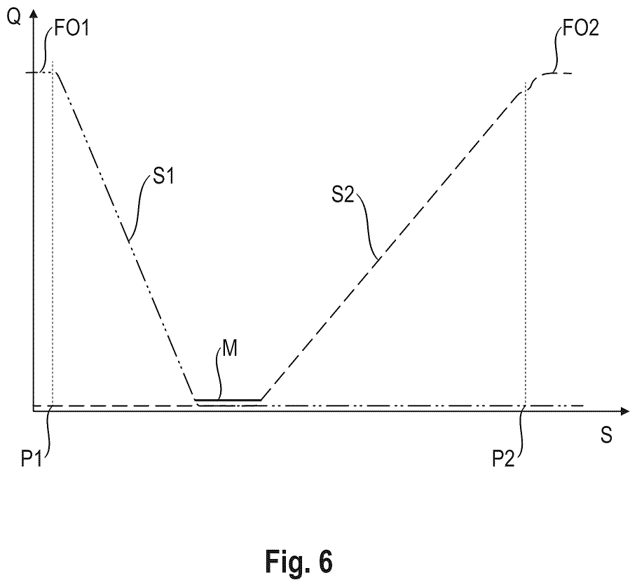

The inflow port 140 comprises a second opening contour 144 that is configured to open the first flow path 162 with a first slope S1 of a flow cross-section expansion when the valve piston 210 is moved into the first end position P1. In addition, the inflow port 140 comprises a first opening contour 142 that is configured to open the second flow path 164 with a second slope S2 of a flow cross-section expansion when the valve piston 210 is moved into the second end position P2. For a more detailed description of the relationship between the first opening contour 142 and the second flow path 164, as well as the second opening contour 144 and the first flow path 162, reference is made to the description of FIG. 6.

FIG. 1B shows a sectional view of the lateral surface of the valve housing 130. The inflow port 140 comprises the first opening contour 142, which is configured to open the second flow path 164 with a first slope S1 of a flow cross-section expansion when the valve piston 210 is moved to the second end position P2. In addition, the inflow port 140 comprises the second opening contour 144, which is located opposite the first opening contour 142 and is configured to open the first flow path 162 with a second slope S2 of a flow cross-section expansion when the valve piston 210 is moved to the first end position P1.

The second opening contour 144 comprises an annular groove 170 in the valve chamber wall 132, the annular groove 170 partially intersecting with the inflow ports 140 arranged radially to the valve housing 130.

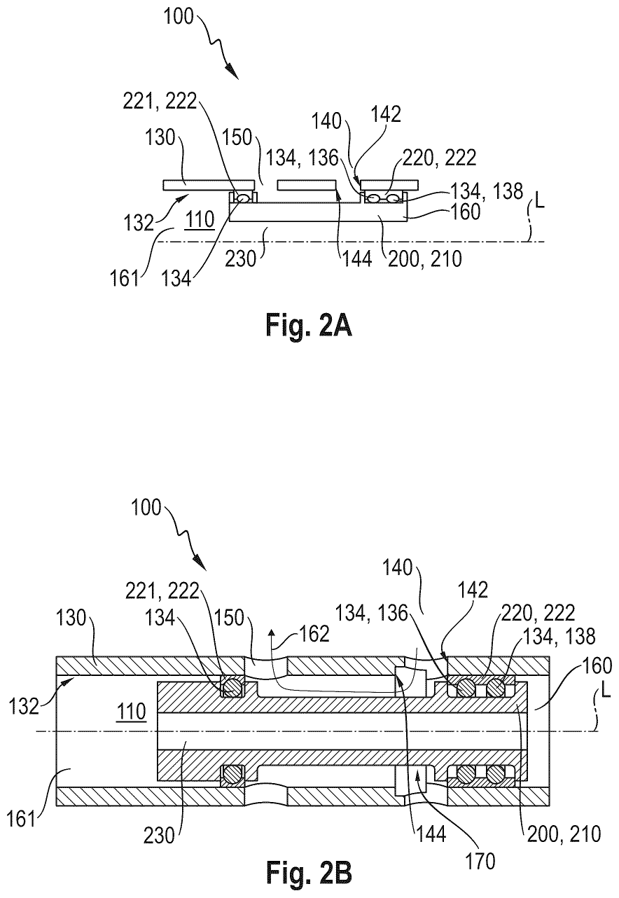

FIG. 2A shows a valve assembly 100 in a schematic sectional view according to the first embodiment, wherein the valve body 200 is in the first end position P1. The valve body 200 is located in the first end position P1, whereby the first flow path 162 is released. In this case, operating medium can flow through the inflow port 140 into the valve housing 130 and out of the valve housing 130 through the first outflow port 150. When flowing in through the inflow port 140, the operating fluid passes over the second opening contour 144. The second flow path 164 is closed in this position.

The first sealing portion 220 is positioned radially against the valve chamber wall 132 by means of a first biasing element 136 and a second biasing element 138. For a better seal, the first biasing element 136 and the second biasing element 138 are spaced apart from one another in the direction of the valve piston longitudinal axis L. The second sealing portion 221 also includes a sealing element 222 for engaging the valve chamber wall 132, wherein a biasing means 134 supports the radial positioning of the sealing element 222 against the valve chamber wall 132.

FIG. 2B shows a detailed cross-section of the valve assembly 100 in the first end position P1. The position is comparable to that shown in FIG. 2A. The second opening contour 144 comprises the annular groove 170 in the valve chamber wall 132, the annular groove 170 partially intersecting with the inflow ports 140 arranged radially to the valve housing 130.

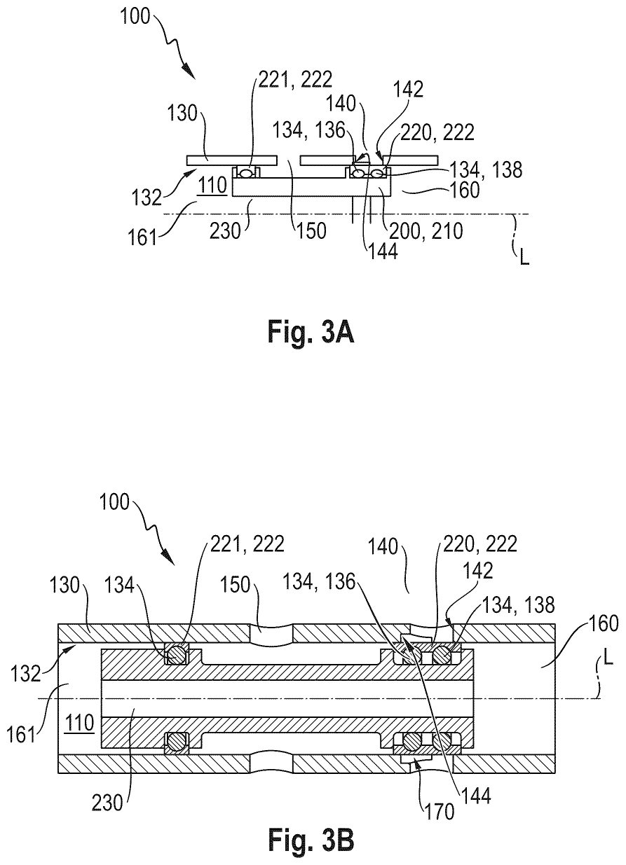

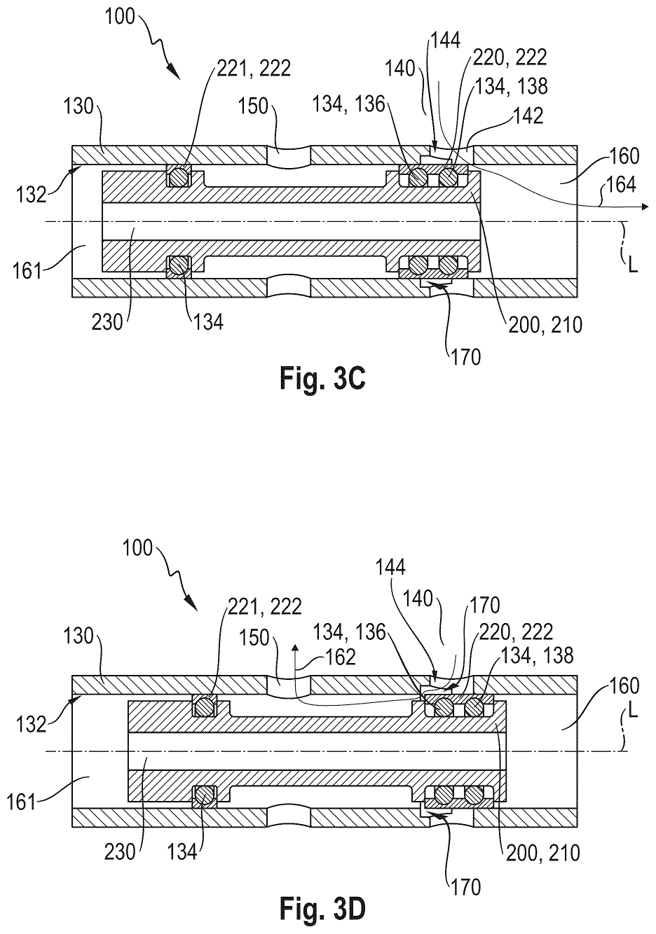

FIG. 3A shows a valve assembly 100 in a schematic sectional view according to the first embodiment, wherein the valve body 200 is arranged in the central position M. Both the first flow path 162 and the second flow path 164 are closed. In this case, operating medium cannot flow through the inflow port 140 into the valve housing 130.

FIG. 3B shows a detailed sectional view of the valve assembly 100 in the central position M. Both the first flow path 162 and the second flow path 164 are closed. Furthermore, the annular groove 170 is entirely covered by the first sealing portion 220.

FIG. 3C shows a detailed sectional view of the valve assembly 100, wherein the valve piston 210 is displaced from the central position M in the direction of the second end position P2. The second flow path 164 is released. In this case, operating medium can flow into the valve housing 130 through the inflow port 140 and again out of the valve housing 130 through the second outflow port 160. When flowing in through the inflow port 140, the operating fluid flows over the first opening contour 142. The first flow path 162 is closed in this position.

FIG. 3D shows a detailed sectional view of the valve assembly 100, wherein the valve piston 210 is displaced from the central position M in the direction of the first end position P1. The first flow path 162 is partially released, allowing operating medium to flow through the inflow port 140 into the valve housing 130 and out of the valve housing 130 through the first outflow port 150. When flowing in through the inflow port 140, the operating fluid flows over the second opening contour 144, with the annular groove 170 influencing the slope S1 of the flow cross-section expansion when opening the first flow path 162. The second flow path 164 is closed in this position.

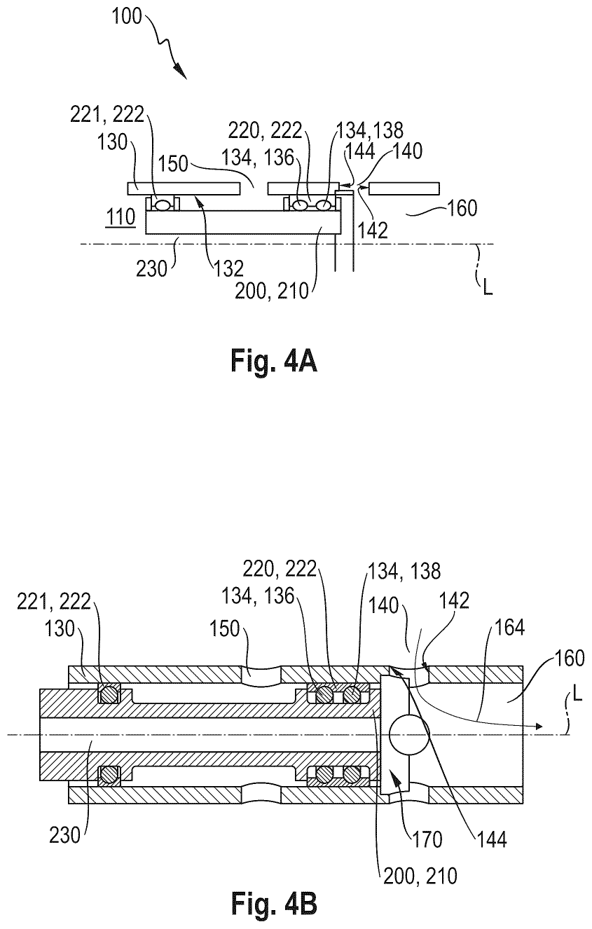

FIG. 4A shows a valve assembly 100 in a schematic sectional view according to the first embodiment, wherein the valve body 100 is in the second end position P2. The second flow path 164 is released. In this case, operating medium can flow into the valve housing 130 through the inflow port 140 and again out of the valve housing 130 through the second outflow port 160. When flowing in through the inflow port 140, the operating fluid passes over the first opening contour 142. The first flow path 162 is closed in this position.

FIG. 4B shows a detailed sectional view of the valve assembly 100, wherein the valve piston 210 is in the second end position P2. The annular groove 170, which is assigned to the second opening contour 144, has no influence on the second flow path 164.

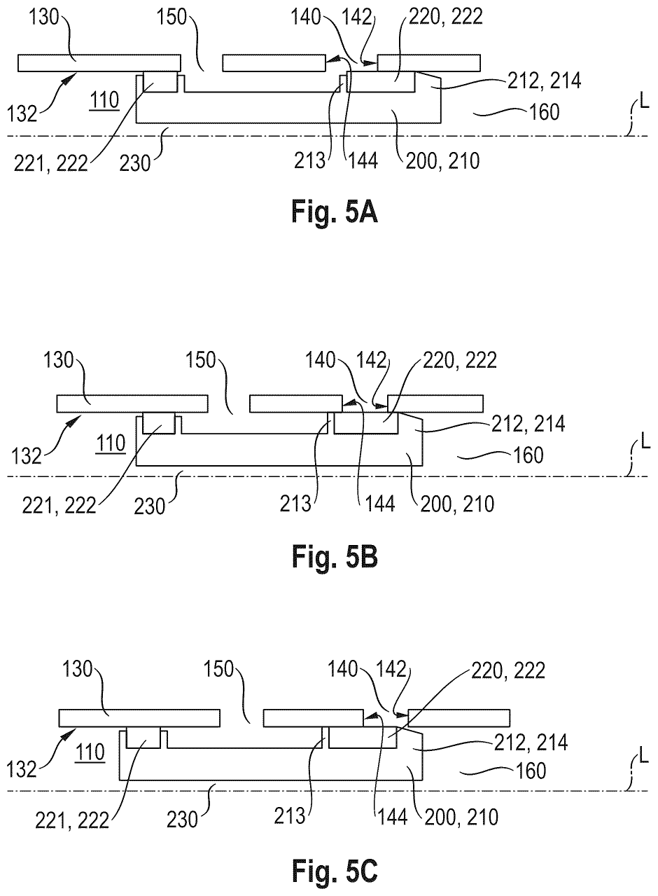

FIG. 5A shows a valve assembly 100 in a schematic sectional view according to a further embodiment. As in the previous embodiments, the valve assembly 100 comprises the valve chamber 110, which is arranged in the valve housing 130. The valve housing 130 comprises the inflow port 140, the first outflow port 150 and the second outflow port 160. A first flow path 162 can be formed between the inflow port 140 and the first outflow port 150, and a second flow path 164 can be formed between the inflow port 140 and the second outflow port 160. The opening or closing of the first and second flow paths 162, 164 depends on the position of a valve body 200 in this embodiment, too. The valve body 200 is arranged within the valve chamber 110 and is designed to move between a first end position P1 for releasing the first flow path 162, a second end position P2 for releasing the second flow path 164 and a central position M for blocking the first and second flow paths 162, 164. In the central position M, the inflow port 140 is closed. The valve body 200 comprises a valve piston 210 that is linearly displaceable between the first end position P1 and the second end position P2, wherein the valve piston 210 comprises a first sealing portion 220. The first sealing portion 220 is arranged in an annular shape around the valve piston 210 and seals with respect to the valve housing 130. A second sealing portion 221 is also designed to be in contact with the valve chamber wall 132.

In distinction to the above embodiment, the valve piston 210 comprises a third opening contour 212. The third opening contour 212 is located on a piston tip 214 and is designed as a conical or frusto-conical taper. In addition, there is a fourth opening contour 213 on the valve piston 210, which is located at the opposite end of the third opening contour 212 on the valve piston 210. Thus, the third opening contour 212 and the fourth opening contour 213 are assigned to the first flow path 162 and the second flow path 164.

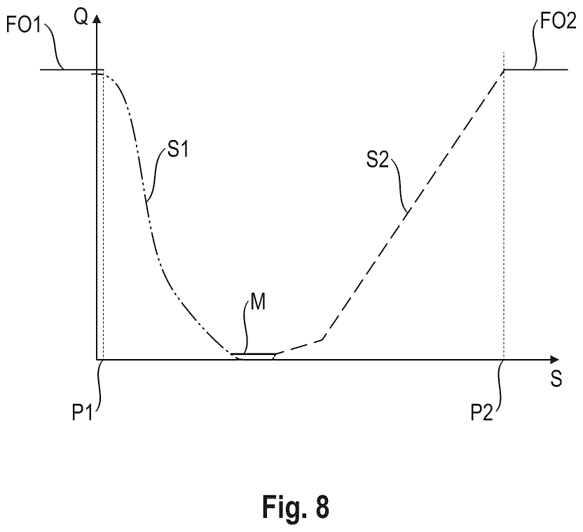

In this embodiment, the inflow port 140 in conjunction with the fourth opening contour 213 is designed to open the first flow path 162 with a first slope of a flow cross-section expansion when the valve piston 210 is moved into the first end position P1. In addition, the inflow port 140, in conjunction with the third opening contour 212, is designed to open the second flow path 164 with a second slope of a flow cross-section expansion when the valve piston 210 is moved to the second end position P2. For a more detailed description of the relationship between the opening contours 212, 213 and the first and second flow paths, reference is made to the description of FIG. 8.

The valve body 200 is in a displaced position in the direction of the first end position P1, whereby the first flow path 162 is released. In this case, operating medium can flow through the inflow port 140 into the valve housing 130 and out of the valve housing 130 again through the first outflow port 150.

FIG. 5B shows a valve assembly 100 in a schematic sectional view according to the embodiment of FIG. 5A, wherein the position of the valve body 200 is displaced with respect to the valve housing 130 compared to FIG. 5A. The valve body 200 is in the central position M, whereby the first flow path 162 and the second flow path 164 are closed. In this case, operating medium cannot flow through the inflow port 140 into the valve housing 130.

FIG. 5C shows a valve assembly 100 in a schematic sectional view according to the embodiment of FIG. 5A, wherein the position of the valve body 200 with respect to the valve housing 130 is displaced compared to FIG. 5A and FIG. 5B. The valve body 200 is in a displaced position in the direction of the second end position P2, thereby releasing the second flow path 164. In this case, operating medium can flow through the inflow port 140 into the valve housing 130 and again out of the valve housing 130 through the second outflow port 160. When flowing in through the inflow port 140, the operating fluid flows over the third opening contour 212. The first flow path is closed in this position.

FIG. 6 shows an exemplary illustration of the progression of the flow cross-section expansion of the first flow path 162 and the second flow path 164 when the valve body 200 is moved between the first end position P1 and the second end position P2. The illustration shows the position [path S] of the valve body 200 within the valve housing 130 on the abscissa axis. The flow cross-section [cross-section Q] is shown on the ordinate axis.

The end position P1 corresponds to the first end position P1 of the valve body 200. In this position, the flow cross-section FO1 of the first flow path 162 is in a fully open position. In the first end position P1, the second flow path 164 is completely closed. When the valve body 200 is moved away from the first end position P1, it reaches the middle position M. In the middle position M, both the first flow path 162 and the second flow path 164 are closed. During the transfer of the valve body 200 from the first end position P1 to the middle position M, the flow cross section of the first flow path 162 is reduced proportionally by means of the slope S1 and is finally completely closed in the middle position M.

The end position P2 corresponds to the second end position P2 of the valve body 200. In this position, the flow cross-section FO2 of the second flow path 164 is in a fully open position. In the second end position P2, the first flow path 162 is completely closed. When the valve body 200 is moved from the central position M to the second end position P2, the first flow path 162 remains closed while the flow cross-section of the second flow path 164 continuously increases. The flow cross-section of the second flow path 164 increases proportionally to the slope S2 and finally reaches a maximum FO2 in the second end position P2. The slope S1 and slope S2 differ due to the first opening contour 142 and the second opening contour 144 at the inflow port 140.

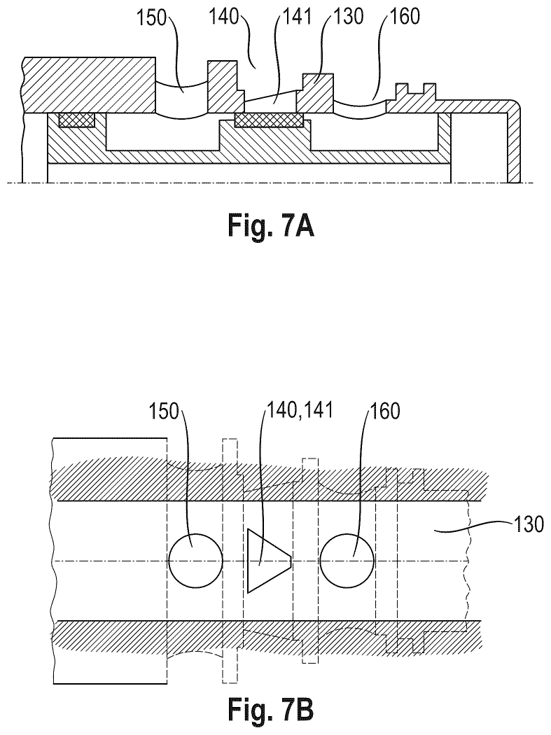

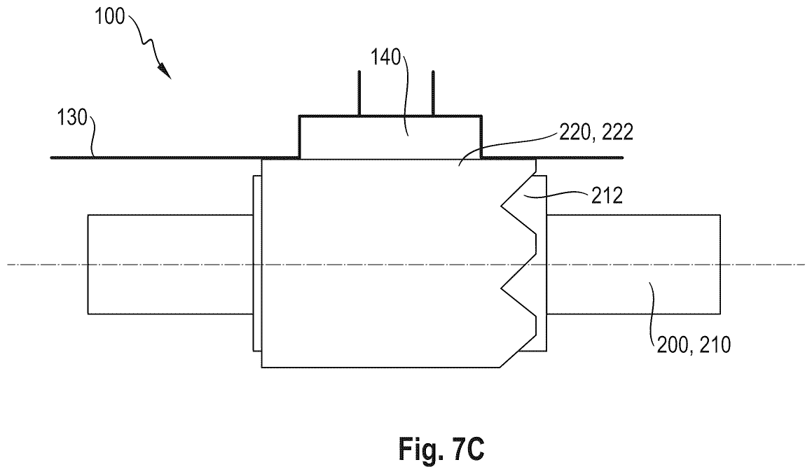

FIG. 7A shows a valve assembly 100 in a sectional view according to an additional embodiment. The valve assembly 100 comprises features that are largely identical to those of the above-mentioned embodiments. A repeated description thereof is omitted at this point.

In distinction to the above-mentioned embodiments, the inflow port 140 comprises a trapezoidal opening 141, which is formed on the valve housing 130. A further difference is that the second outflow port 160 for outflow of fluid is not formed in the axial direction but in the radial direction out of the valve housing 130.

FIG. 7B is a plan view of the valve assembly 100 of FIG. 7A. In this embodiment, the inflow port 140 having the trapezoidal opening 141 is designed to open both the first flow path 162 when the valve piston 210 is moved to the first end position P1 and the second flow path 164 when the valve piston 210 is moved to the second end position P2. Due to the trapezoidal opening 141, the slope of the flow cross-section expansion is different for the first flow path 162 compared to the second flow path 164. For a more detailed description of the relationship between the trapezoidal opening 141 and the first and second flow paths, reference is made to the description of FIG. 8.

FIG. 7C shows a valve body 200 in a schematic side view according to one embodiment. The valve body is part of a valve assembly 100. The valve body 200 includes a third opening contour 212, which is arranged directly in the sealing element 222. The third opening contour 212 is designed on one end face of the sealing element 222 in an exemplary serrated manner and is assigned to the second flow path 164. Thus, the third sealing element 222 influences the course of the flow cross-section change of the second flow path 164 when the valve body 200 is transferred from the first end position P1 to the second end position P2. The shape of the sealing element edge can be freely chosen to suit the requirement.

FIG. 8 shows a further exemplary representation of the course of a flow cross-section expansion of the first flow path 162 and the second flow path 164 when the valve body 200 is moved from the first end position P1 to the second end position P2. The illustration shows the position [path S] of the valve body 200 within the valve housing 130 on the abscissa axis. The flow cross-section [cross-section Q] is shown on the ordinate axis.

The end position P1 corresponds to the first end position P1 of the valve body 200. In this position, the flow cross-section FO1 of the first flow path 162 is in a fully open position. In the first end position P1, the second flow path 164 is completely closed. When the valve body 200 is moved away from the first end position P1, it reaches the central position M. In the central position M, both the first flow path 162 and the second flow path 164 are closed. During the transfer of the valve body 200 from the first end position P1 to the central position M, the flow cross-section of the first flow path is reduced in a non-proportional manner by means of a slope S1 and is finally completely closed in the central position M. Such a non-proportional slope S1 can be achieved, for example, by a fourth opening contour 213 (not shown) on the sealing element 222.

The end position P2 corresponds to the second end position P2 of the valve body 200. In this position, the flow cross-section FO2 of the second flow path 164 is in a fully open position. In the second end position P2, the first flow path 162 is completely closed. When the valve body 200 is moved from the central position M to the second end position P2, the first flow path 162 remains closed while the flow cross-section of the second flow path 164 continuously increases. The flow cross-section of the second flow path 164 increases proportionally by means of the slope S2 and finally reaches a maximum FO2 in the second end position P2. The slope S1 and slope S2 differ due to the third opening contour 212 (see FIG. 7C) and the fourth opening contour 213 on the sealing element 222.

List of reference signs

| | |
|---|---|
| 100 | valve assembly |
| 110 | valve chamber |
| 130 | valve housing |
| 132 | valve chamber wall |
| 134 | biasing means |
| 136 | first biasing element |
| 138 | second biasing element |
| 140 | inflow port |
| 141 | trapezoidal opening |
| 142 | first opening contour |
| 144 | second opening contour |
| 150 | first outlet port |
| 160 | second outlet port |
| 161 | free outlet port |
| 162 | first flow path |
| 164 | second flow path |
| 170 | annular groove |
| 200 | valve body |
| 210 | valve piston |
| 212 | third opening contour |
| 213 | fourth opening contour |
| 214 | Piston tip |
| 220 | first sealing portion |
| 221 | second sealing portion |
| 222 | sealing element |
| 230 | through-opening |
| L | longitudinal axis |
| P1 | first end position |
| P2 | second end position |
| M | central position |
| FO1 | fully open flow cross-section of the first flow path |
| FO2 | fully open flow cross-section of the second flow path |
| S1 | first slope |
| S2 | second slope |

What is claimed is:

1. A valve assembly for cooling fluid comprising:
a valve housing comprising a valve chamber, the valve housing further comprising an inflow port, a first outflow port, and a second outflow port, wherein a first flow path is formed between the inflow port and the first outflow port and a second flow path is formed between the inflow port and the second outflow port,
a valve body arranged within the valve chamber and configured to be movable between a first end position (P1) for enabling the first flow path, a second end position (P2) for enabling the second flow path and a central position (M) for blocking the first and the second flow path including the inflow port.

2. The valve assembly according to claim 1, wherein the valve body is formed by a valve piston linearly displaceable between the first end position and the second end position.

3. The valve assembly according to claim 1, wherein the valve piston comprises a first sealing portion sealing against the valve housing.

4. The valve assembly according to claim 3, wherein the first sealing portion extends annularly around the valve piston and comprises a length along a valve piston longitudinal axis (L) of the valve piston which is greater than a length of an inflow geometry of the inflow port.

5. The valve assembly according to claim 3, wherein the first sealing portion comprises a sealing element for engagement with a valve chamber wall and biasing means for radially positioning the sealing element against the valve chamber wall.

6. The valve assembly according to claim 5, wherein the biasing means comprises a first biasing element and a second biasing element, the first biasing element and the second biasing element arranged at a distance from one another in the direction of the valve piston longitudinal axis (L).

7. The valve assembly according to claim 1, wherein the inflow port comprises:
a first opening contour configured to open the second flow path with a first slope (S1) of a flow cross-section expansion when the valve piston is moved into the second end position, and
a second opening contour configured to open the first flow path with a second slope (S2) of a flow cross-section expansion when the valve piston is moved into the first end position, the first slope (S1) being different from the second slope (S2).

8. The valve assembly according to claim 7, wherein an annular groove in the valve chamber wall is assigned to at least one of the first opening contour or the second opening contour, the annular groove being connected to the inflow port.

9. The valve assembly according to claim 8, wherein a cross-section geometry of the inflow port is configured to be non-uniform in the direction of the valve piston longitudinal axis (L).

10. The valve assembly according to claim 1, wherein the valve piston comprises a third opening contour.

11. The valve assembly according to claim 10, wherein the valve piston comprises a piston tip, the third opening contour being formed by a conical or frusto-conical tapering of the piston tip or by at least one radial recess in the piston tip extending as far as an axial end face of the piston tip.

12. The valve assembly according to claim 1, wherein the inflow port is formed by a round or polygonal, triangular or trapezoidal, opening of the valve housing.

13. The valve assembly according to claim 1, wherein the valve assembly is of pressure-equalized design.

14. The valve assembly according to claim 2, wherein the valve piston comprises a through-opening for pressure equalization.

15. The valve assembly according to claim 1, wherein the valve assembly comprises an electrically actuable drive for proportionally actuating the valve body.
